(19) United States
(12) Patent Application Publication
(10) Pub. No.: US 2022/0318727 A1
(43) Pub. Date: Oct. 6, 2022

(54) LIVE INVENTORY MANAGEMENT SYSTEM AND METHODS THEREOF

(71) Applicant: VDMS Limited (Ireland), Offaly (IE)

(72) Inventor: Marcin Sienicki, Brendale (AU)

(73) Assignee: VDMS Limited (Ireland), Offaly (IE)

(21) Appl. No.: 17/615,938

(22) PCT Filed: Jun. 3, 2020
(86) PCT No.: PCT/US2020/035806

§ 371 Date: Dec. 2, 2021

Related U.S. Application Data
(60) Provisional application No. 62/856,416, filed on Jun. 3, 2019.

(51) Int. Cl. G06Q 10/08; G06Q 20/20; G07F 9/02; G07F 11/62; A47F 1/12; A47F 10/02

(52) U.S. Cl. CPC G06Q 10/087; G06Q 20/203; G07F 9/026; G07F 11/62; A47F 1/126; A47F 10/02; A47F 2010/025

(57) ABSTRACT

Live inventory management environment system and methods are disclosed. A shelf for items has bins each with an associated sensor. A processor receives a detection signal from the sensor which indicates placement or removal an item(s) from an associated bin. An entry device sends an entered request for placement or removal of items to the processor, and an indicator strip has lights which uniquely identify each one of the bins when lit. The processor has information relating to which bin each subset of lights is associated, and causes activation of a subset of lights associated with a bin of the item(s) in the request and records in memory a type of action, a time stamp and a quantity of the item(s) placed or removed from the bin having the subset of lights lit and indicated in the detection signal subsequently received from the sensor of the associated bin.

### CROSS REFERENCE TO RELATED APPLICATION

This application claims benefit to U.S. Provisional Application 62/856,416, filed Jun. 3, 2019, which is herein incorporated by reference in its entirety.

### TECHNICAL FIELD

The present disclosure relates generally to the field of item storing on shelves in retail, and particularly to the ability to have ongoing “live counts” of items in each location, such as within a convenience store, in which a system automatically counts the products and guides a store employee or a central office system to the specific total of each set of products and time stamps movements of products either into each array or out of the array. The live transactional reports can also be used to cross reference against POS records to cut down on shrinkage.

### BACKGROUND

Retail outlets worldwide are increasingly at risk of losing product to theft and/or shrinkage where store staff sometimes take products for themselves or “gift” to friends. The cost of inventory lost to such behavior is estimated to be close to $50 Billion dollars in the US market annually and retail stores are investing huge amount of time each day to counting stock to try to keep more control over their stock. The cost per retail outlet of counting product each day or shift is estimated to be over $7000 dollars per year for those accounts committed to reducing employee shrinkage.

### SUMMARY

It is against the above background that a live inventory management environment (LIME) system and methods thereof are disclosed herein. Although useful in a wide variety of applications, the LIME system will find its greatest use in tracking items with significant value and demand such as tobacco products, pharmaceutical products, batteries etc within a retail store environment.

In one exemplary embodiment, the LIME system comprises a lighting system which guides a store clerk to a specific bin which holds a purchased item and includes a live inventory management application of items held by the bin.

In another embodiment, the LIME system described herein provides a shelf having a plurality of dividers which divide the shelf into a plurality of bins for holding visibly indistinguishable items. A time of flight based sensor may be associated with each one of the plurality of bins to detect placement or removal of one or more of the items from the associated bin. A processor, having a memory which stores a list of items which are held within each of the bins, may be in communication with the sensor to receive a detection signal which indicates the placement or removal of the one or more of the items from the associated bin. An entry device in communication with the processor sends entered requests for item placement or removal to the processor. An indicator strip is attached to the shelf, e.g., along the edge of the shelf, wherein the indicator strip has a set of lights linearly arranged in an single dimension such that an associated subset of the set of lights comprising two or more lights uniquely identifies an associated one of the bins when lit, wherein the strip is in communication with the processor and wherein the processor further includes information relating to which bin each subset of the set of lights of the strip is associated. Selection of one of the items from the list of items via the entry device causes the processor to send a signal to actuate the subset of the set of the plurality of lights which is associated with the bin with the selected item, and to record in memory a timestamp and quantity of the one or more of items placed or removed from the associated bin having the subset of the set of lights light and indicated in the detection signal subsequently received from the sensor of the associated bin.

In still another embodiment, a method for dispensing items from a dispensing and live inventory management system is disclosed. The system comprises a shelf having a plurality of dividers which divide the shelf into a plurality of bins for holding visible items, a time of flight based sensor associated with each one of the plurality of bins to detect placement or removal of one or more of the items from the associated bin, a processor having a memory which stores a list of items which are held within each of the bins and being in communication with the sensor to receive a detection signal which indicates the placement or removal of one or more items from the associated bin, an entry device in communication with the processor which sends entered requests for placement or removal of the one or more items to the processor, and an indicator strip attached to the shelf, wherein the indicator strip has a set of lights linearly arranged in an single dimension such that an associated subset of the set of lights comprising two or more lights uniquely identifies one of the bins when lit, wherein the strip is in communication with the processor and wherein the processor further includes information relating to which bin each subset of the set of lights of the strip is associated, and wherein selection of at least one of the items from the list of items via the entry device causes the processor to send a signal to actuate the subset of the set of the plurality of lights which is associated with the bin with the one or more items selected, and to record in memory a type of action being selected from a placement and a removal, a timestamp and a quantity of the one or more items selected placed or removed from the associated bin having the subset of the set of lights light and indicated in the detection signal subsequently received from the sensor of the associated bin. The method comprises storing in memory of the system: a list of items which are held within each of the bins, and information relating to which bin each subset of the set of lights of the strip is associated with each item; receiving via the processor entered requests for placement or removal of one or more selected items sent from the entry device to the processor; sending via the processor a signal to actuate the subset of the set of the plurality of lights which is associated with the bin with the one or more selected items; and recording in memory the type of action selected from a placement and a removal, the timestamp and the quantity of the one or more selected items placed or removed from the associated bin having the subset of the set of lights light and indicated in a detection signal subsequently received from the sensor of the associated bin.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a depiction which illustrates a high level representation a live inventory management environment (LIME) system according to an exemplary embodiment, with an expanded view of an included shelf from a cabinet;

FIG. 2 is a depiction that shows details of various components of the LIME system of FIG. 1 according to an exemplary embodiment;

FIG. 3 is a schematic block diagram of a process logic controller and other various components of the LIME system of FIG. 1 according to an exemplary embodiment;

FIG. 4 is a depiction that shows expanded details of other various components of the LIME system of FIG. 1 according to an exemplary embodiment;

FIG. 5 is a flow chart that depicts machine logical processes/programming of a selection workflow implemented by the LIME system of FIG. 1 according to an exemplary embodiment; and

FIG. 6 is a flow chart that depicts machine logical processes/programming of a stock take/replenishment workflow implemented by the LIME system of FIG. 1 according to an exemplary embodiment.

FIGS. 7-20 depict an embodiment of the LIME system disclosed by FIGS. 1-6 implemented as a retrofit kit for legacy product dispensing machines.

### DETAILED DESCRIPTION

As used herein, the follow terms mentioned hereinafter refer to or have the following meaning.

The term “Application Programming Interface (API)” refers to a programming bridge between various internal software and hardware applications that allows for easy connectivity to other third party applications.

The term “Bright Markets” is tobacco industry nomenclature indicating regional jurisdictions where branded tobacco packaging is permitted (Bright).

The term “Dark Markets” is tobacco industry nomenclature indicating regional jurisdictions where branded tobacco packaging is prohibited (Dark).

The term “Light Emitting Diode (LED)” is an electronic component that emits light if current is applied in a particular direction through it.

The term “Process Logic Controller (PLC)” refers to a programmable microprocessor based controller that manages control of a hardware apparatus, and which is typically used to translate analogue or digital signals and provide electronic transport in industry standard computing, communication and networking formats.

The term “Point-Of-Sale (POS) device” refers to a retail cash register, e.g. a retail-adapted personal computer with sophisticated accounting, dispensing and cash management software running thereon.

The term “Pusher” refers to a spring loaded packaging arrangement that always ensures that product stacked inside it is “pushed” to the front of the arrangement.

The term “Pulse Width Modulation (PWM)” refers to a technique by which various similar components (such as arrays of LEDs) can identify themselves sequentially in an electrical array by encoding a short unique ID in a pulsing signal.

The term “Time of Flight Sensor” (ToF) refers to a method for measuring the distance between a sensor and an object, based on the time difference between the emission of a signal and its return to the sensor, after being reflected by an object.

The term “FMCG” refers to fast moving consumer goods, items like cigarettes, bottled and canned drinks, batteries, nonprescription pharmaceutical goods, chocolate etc.

The term “Shrinkage” is a retail industry description of stock that is unaccounted for, e.g., stolen, destroyed, misplaced, etc., and typically caused by staff at various stages in the supply chain.

An “interstitial” refers to a software application's window displayed before or after an expected content window and is presented on a display screen for a predetermined amount of time before closing either automatically or via manual user interaction before expiration of the predetermined amount of time.

A “modal window” refers to a graphical control element subordinate to a software application's main window. It creates a mode that disables the main window but keeps it visible with the modal window as a child window in front of it. Users must interact with the modal window before they can return to the main (parent) window of the software application.

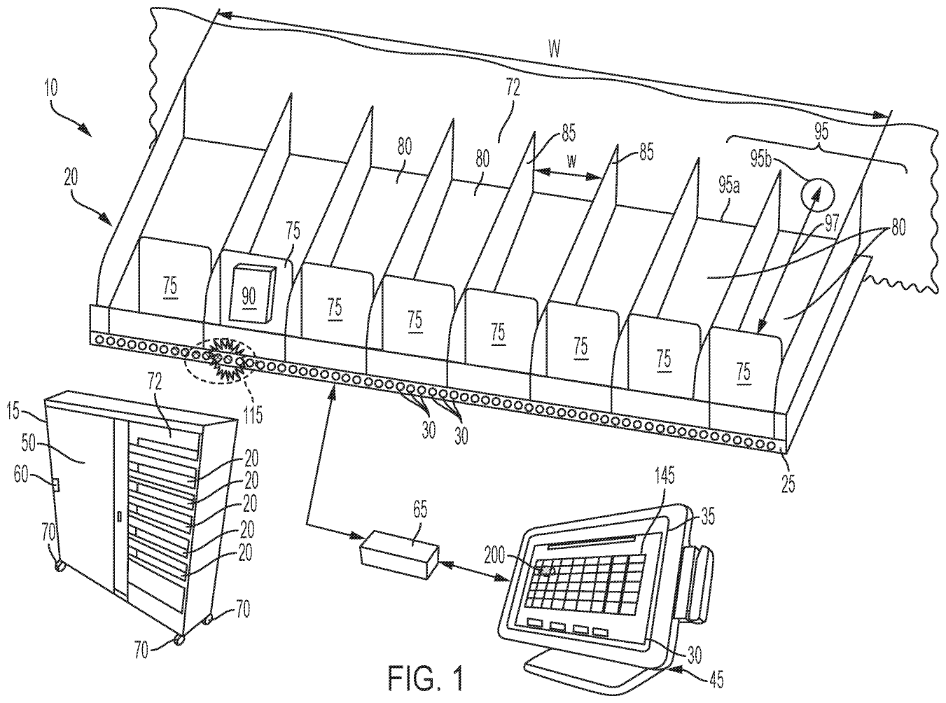

Referring now to FIG. 1, a high level representation of a live inventory management environment (LIME) system 10 according to an exemplary embodiment is depicted. The LIME system 10 primarily facilitates the sales of various tobacco products or other uniformly packaged FMCG. Another such example is disclosed by pending and co-owned International Application No. PCT/IB2018/001135, the disclosure of which is herein incorporated fully by reference.

Pack commoditization are resulting in highly stressful “switchover” scenarios, whereby previously easily identifiable tobacco and FMCG products are virtually indistinguishable from each other, right down to uniformity even in the size of the packaging. This lack of individuality across multitudes of different products carried at a sales location (often 200+) is a challenging daily scenario for both retail staff and various other participants in the supply and procurement chain of tobacco and other FMCG. In view of such, the LIME system 10 provides a means in which to quickly identify the position of such not clearly identifiable goods in a gantry arrangement or cabinet 15 of one or more shelves 20 by means of a highly visible, illumination indicator strip 25 providing a plurality of lights 30 and/or a screen interaction/graphical user interface (GUI) 35 provided on a display 40, e.g., of a POS device 45. The LIME system 10 also provides real-time management of stock and accounting of the various dispenses and replenishments occurring during the day to the different products, thus making a highly tedious process of physically counting products at the end of a shift or accounting period virtually redundant.

As depicted in FIG. 1, in one exemplary embodiment, the cabinet 15 provides a sales location, such as within a convenience store, gas station, grocery store, liquor store, etc., from which to hold and dispense various FMCG items. The cabinet 15 in one embodiment has one or more doors 50 to enclose within an enclosure 55 of the cabinet 15 a plurality of retractable and/or fixed shelves 20. Although the illustrated embodiment of FIG. 1 is shown with two doors and six shelves, the number of doors and shelves may be varied as desired or may not have doors. For example, the cabinet 15 may include one to twenty doors, and two to thirty shelves in any row and/or column fashion, e.g., a single stack of shelves (one over the other) or two or more columns of such stacked shelves arranged side by side. In another embodiment, an overhead/gantry arrangement of one or more shelves 20 that may hidden from public view may be provided in addition to or instead of cabinet 15. In certain embodiments, the cabinet 15 and/or each shelf 20 may have a lock 60 to prevent access to the cabinet and/or shelf when locked e.g., preventing a retractable shelf from retracting from the cabinet and/or opening a protective cover (not shown) to the shelf. In still another embodiment, the lock 60 stays locked until receiving a signal from a controller 65 of the LIME system 10 to unlock and likewise can be locked either manually or automatically via another signal from the controller. Such remotely operated locks are disclosed by U.S. Pat. Nos. 6,297,725, 7,728,711 and 8,996,164, the disclosures of which are herein incorporated fully by reference.

As depicted in FIG. 1, the cabinet 15 may rest upon a plurality of wheels 70, be free-standing, or wall-mounted as desired. The cabinet 15 may also be fashioned with various dimensions. For example, the cabinet 15 may have a size from about 12 to 300 inches wide, 0.5 to 8 feet high, and 3 to 60 inches deep from the door 40 to a back wall 72 thereof.

As also depicted by FIG. 1, in the expanded view depicting a representative one of the shelves 20, each shelf has one or more pushers 75 associated with a plurality of bins 80. A plurality of transverse dividers 85 divide the shelf 20 into the plurality of bins 80. Each bin 80 is used to hold visible items 90, e.g., like tobacco products in or other FMCG. Although bins 80 are depicted in FIG. 1 as being evenly spaced/sized along (and transverse to) a major width W of shelf 20, the dividers 85 can be adjustable and/or removable in order to adjust a minor width w of each bin as well as the number of bins provided per shelve. For example, one shelf 20 may have fewer or more bins 80 then the other bins in order are to accommodate items 90 that are of different shapes and/or sizes like, e.g., cigarettes, cigarette cartons, cigars, cigar boxes, chewing leaf pouches, snuff boxes, loose leaf (pipe) tobacco jars, batteries, nonprescription pharmaceutical products and the like. To be retractable, each shelf 20 may comprise a conventional frame/retractable shelf mechanism (not shown) having an associated track(s) which allows the shelf to be slid in and out of cabinet 15 (FIG. 1). As each shelf 20 may have more or fewer bins 80 in order are to accommodate items of different shapes and sizes, one or more of the pushers 75 may be associated with each bin 80. For example, in a shelf 20 containing cigarette cartons, two or more pushers 75 may be used in an oversized one of the bins 80 that is formed by removing/bringing together one or more adjacent dividers 85. In other embodiments, each of the pushers 75 may be removable to provide fewer or only one pusher 75 in such an oversized bin, e.g., if movement of the item is better facilitated thereby.

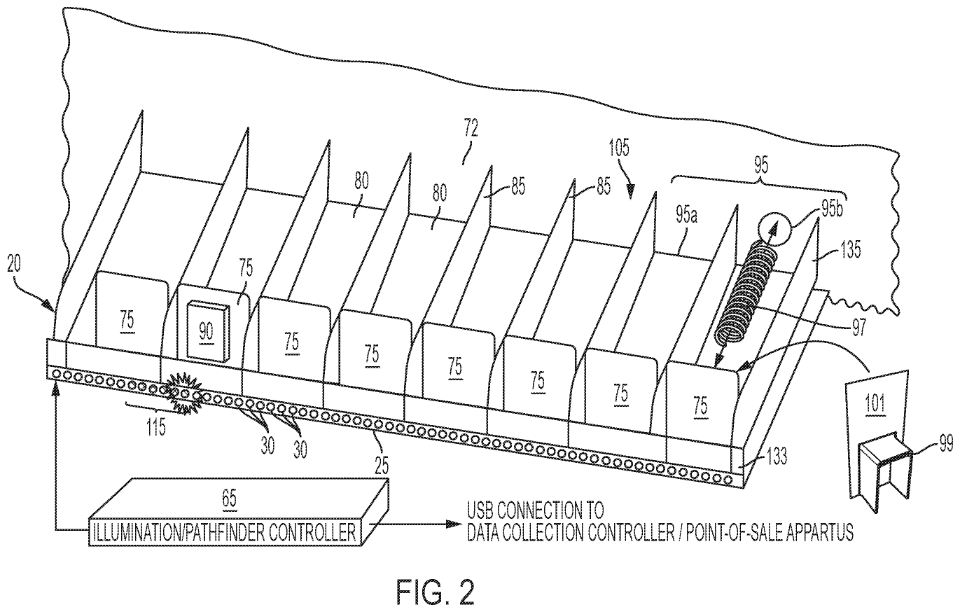

Referring to FIG. 2, a sensor 95 is associated with each one of the plurality of bins 80 to detect placement or removal of one or more of the items 90 from the associated bin 80, and send a detection signal to controller 65. For example, of a sensor and pusher arrangement is disclosed by U.S. Patent Appln. Pub. No. 2005/0279722, the disclosure of which is herein incorporated fully by reference. In another embodiment, sensor 95 may be of the type that detects each incidence of the selected item picked or placed from the associated bin via a difference of measurement/time-of-flight in a transmission and detection of a beam of light 97 from a micro-laser and collector sensor 95b situated adjacent a back side of each bin 80, such as on back wall 72, to and reflecting back from the rear of the pusher 75. An example of a time of flight sensor and pusher arrangement is disclosed by U.S. Patent Appln. Pub. No. 2005/0279722, the disclosure of which is herein incorporated fully by reference. To eliminate any problems of the sensor 95 detecting multiple surfaces during measures, a reference point fixture 99 may be installed on the rear of each pusher 75. The fixture 99 provides a uniformly smooth and reflective surface 101 for the light beam 97, thereby increasing accuracy of the detection result.

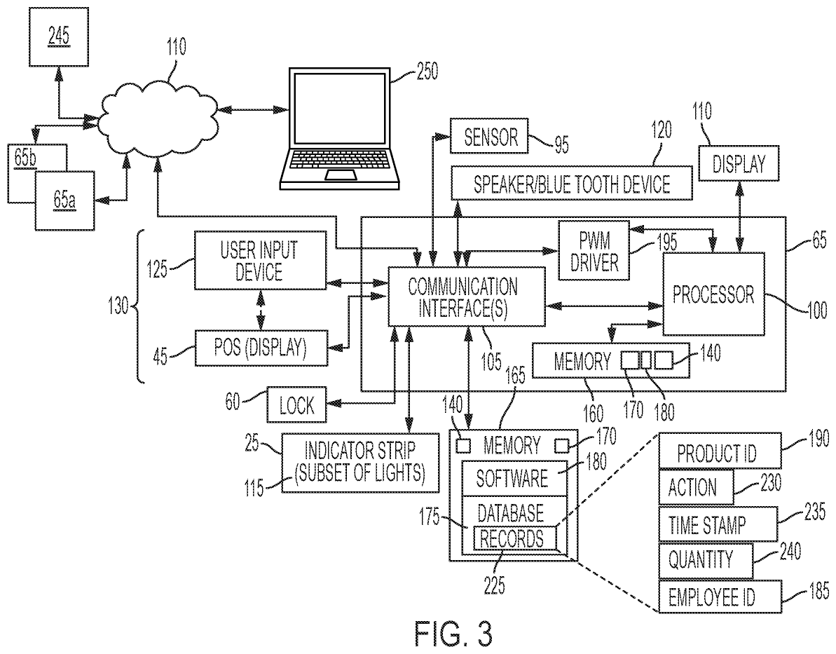

With reference made also to FIG. 3, the controller 65 has a processor 100. The processor 100 can be any device capable of executing machine readable instructions. Accordingly, the processor 100 may be an integrated circuit, a microchip, a computer, or any other computing device. As such, it is to be appreciated that controller 65 in one embodiment may be a standalone device and in other embodiments may comprise, include or be embodied in one or more processing elements which provides a processor, such as one or more of a laptop computer, desktop computer, workstation computer, server computer or the like.

The processor 100 is connected to at least one interface or other means for displaying, transmitting and/or receiving data, content or the like. In this regard, the interface(s) may include at least one communication interface 105 or other means for transmitting and/or receiving data, content or the like, such as to and/or from other devices (e.g., workstation computers) and/or networks 110 coupled to the processor 100 and/or POS device 45. In this regard, the processor 100 may be coupled to one or more networks 110, including one or more wireline and/or wireless local area networks (LANs), wide area networks (WANs) (e.g., the Internet) or the like. In other embodiments, the communication interface 105 can include a communication transceiver for sending and/or receiving data according to any wireless communication standard. For example, the communication interface 105 can include a chipset (e.g., antenna, processors, machine readable instructions, etc.) to communicate over wired and/or wireless computer networks such as, for example, wireless fidelity (Wi-Fi), WiMax, Bluetooth, IrDA, Wireless USB, Z-Wave, ZigBee, or the like.

In the illustrated embodiment of FIG. 3, the processor 100 of the controller 65 is in communication with each sensor 95, such as one or more sensors 95a and/or 95b (FIG. 2), via the communication interface 105. The processor 100 receives the detection signal from the sensor 95 which indicates the placement or removal of one or more of the items 90 from an associated bin 80. The processor 100 also controls, via sending a signal through the communication interface 105, the selective activation of a subset of lights 115 (of the plurality of lights 30) provided along the indicator strip 25 to help guide a store clerk to a specific bin 80 of a specific shelf 20 which holds a purchased item 90 as also depicted by FIGS. 1 and 2.

In addition to the communication interface 105, other interface(s) in communication with the processor 100 may also include a display 110, one or more wired and/or wireless (e.g., Bluetooth, Infrared, etc.) earphones and/or speakers 120 and at least one entry device 130 that may include, for example, a display 30 of POS device 45 and/or a user input device 125. The user input device 125, in turn, may comprise any of a number of wireline and/or wireless devices allowing the controller 65 to receive data from a user, such as a microphone, an image or video capture device, a keyboard or keypad, a joystick, the above-mentioned entry device(s), a magnetic or barcode reader, and/or any other conventional input device. The processor may also include other user interfaces such as a remote computer 250.

As best shown in FIG. 2, the indicator strip 25 is attached to the shelf 20 at a front end 133. By “front end” is meant a side that is opposed to a “back end” 135 of the shelf 20 from which the pusher 75 travels (biased towards) to the front end 133 when items 90 are picked from the associated bin 80. As also depicted, the set of lights 30 of the indicator strip 25 are linearly arranged in a single dimension, e.g., the dimension defined by major width W (FIG. 1), such that the subset of lights 115, comprising two or more lights, uniquely identifies an associated one of the bins 80 when lit/activated by the processor 100. In one embodiment the lights 30 are LEDs. In other embodiments, the lights may be incandescent or florescent bulbs, quantum dots, lasers, and/or photonic crystal light sources.

Referring back to FIG. 3, the indicator strip 25 is in communication/controlled by the processor 100 of the controller 65, wherein the processor 100 includes data/information 140 relating to which bin 80 each subset of lights 115 is associated. In one embodiment, the information 140 relating to which bin 80 each subset of lights 115 is associated is set by entering e.g., a positional numbering of each light located in the strip for the subset of the set of lights. In another embodiment, as shown by FIG. 1, the graphical user interface (GUI) 35 provides a virtual storage arrangement 145 for each shelf 20 at a storage location, such as in cabinet 15 on a display 30, 110 within the LIME 10.

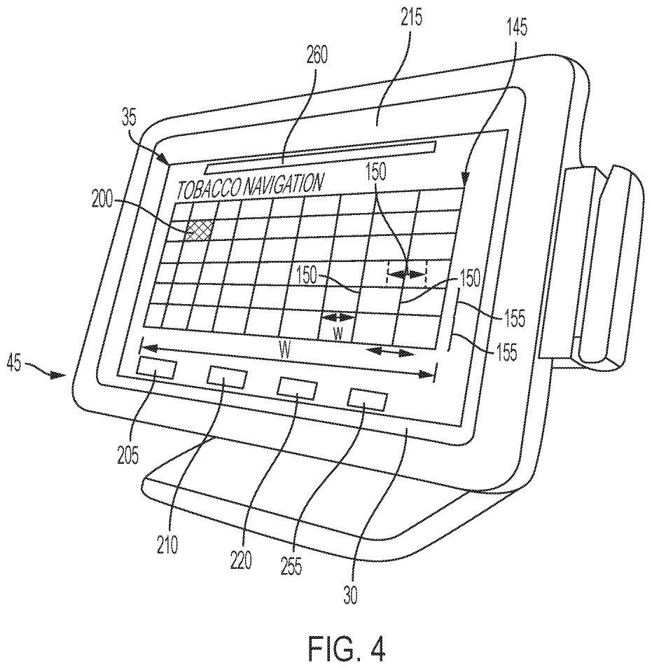

As best depicted by FIG. 4, the virtual storage arrangement 145 provided by the GUI 35 on display 30 of the POS device 45 mimics virtually the physical storage arrangement provided in cabinet 15, i.e. a vertical stacking of six shelves 20 with each shelf having a total of nine bins 80. When in a set-up mode for the GUI 35, the information 140 relating to which bin 80 each subset of lights 115 is associated can be set and entered by movement and placement of an electronically depicted divider 150 for an associated electronically depicted shelf 155 in order for the divider position to directly correspond to the associated bin 80 of the actual/physical shelf 20. The number of electronically depicted dividers 150 and selves 155 may be conveniently adjusted via adding or deleting such electronic depictions from the GUI 35 in order to match the number of actual shelves 20 and dividers 85 defining each bin 80 that is provided at a storage location, such as e.g., in cabinet 15. The width of each graphically depicted shelf 155 may be conveniently adjusted by entering into the application the corresponding physical major width W of each actual shelf 20. It is to be appreciated that in the exemplary embodiments shown by FIGS. 1 and 4, although the number and of shelves 20 and bins 80, and major and minor widths W, w thereof, are all depicted as being equal, each shelf 155 may have a different number of bins as well as major and minor widths W, w, via removing or adding dividers 150 in order to match the physical storage arrangement provided at a physical storage location with the virtual storage arrangement 145.

With reference made again to FIG. 3, the controller 65 has or is in communication with one or more memories 160, 165, which each may store the information 140 regarding the subset of lights 115 and associated bins 80 as well as an item list 170 listing all of the items 90 that are held within each of the bins 80. Each memory 160, 165 can comprise volatile and/or non-volatile memory, and typically stores content, data or the like, such as in one or more databases 175. In this regard, each memory 160, 165 may store content transmitted from, and/or received by, the processor 100, and be either internally provided with the controller 65 as is memory 160 and/or external to the controller 65 as is memory 165. Each memory 160, 165 may also store one or more software application 180 for the processor 100 to perform steps associated with operation of the LIME 10 in accordance with the exemplary embodiments disclosed herein (although any one or more of these steps may be implemented in any combination software, firmware or hardware).

The user input device 125, being in communication with the processor 100, is one form of entry device 130 that sends entered requests for the placement or removal of the one or more items to the processor. In some embodiments, the user input device 125 may comprise a keyboard for entering information into the processor 100 for processing and/or storing in memory 160, 165. For example, the user input device 125 may be employed to enter employee identification information 142, requests for item placement and/or removal, and the like into the processor 100. In other embodiments, the user input device 125 allows the clerk to scroll through the item list 170, such as provided via display 30, 110, in order to make a selection from the one or more items 90. In still other embodiments, the user input device 125 may comprise a magnetic or bar code reader. A code reader allows a clerk to be conveniently identified by swiping an appropriate ID card through reader to provide an employee identification information 185 as well as to read a product identification 190 associated with each item 90 contained in the item list 170 in order to select the one or more items 90.

Selection of at least one of the items 90 via the user input device 125 causes the processor 100 to send a signal, such as a PWM signal from a PWM driver 195 of the controller 65, to actuate the subset of lights 115 associated with the bin 80 holding the one or more items 90 selected. Subsequently to the receipt of the entered requests, if so configured, an unlock signal is sent to the associated lock 60 also by the processor 100. An arrangement of an indicator strip 25 having a subset of lights 115 controlled via a PWM signal from PWM driver 195 is disclosed by U.S. Pat. No. 8,939,604, the disclosure of which is herein fully incorporated by reference.

Referring back to FIGS. 1 and 4, after a selection of the one or more items 90 via the user input device 125, the processor 100, in addition to illuminating automatically the corresponding subset of lights 115, will also electronically indicate automatically the corresponding position of the associated bin 80 containing the one or more items 90 selected within the virtual storage arrangement 122 of the GUI 35. As best depicted by FIG. 4, the corresponding position of the associated bin 80 is indicated electronically on e.g., display 30, via a visible indicator 200, such as an image, icon, differentiating graphic, color change, etc., which highlights virtually the associated physical position of the one or more selected items 90 contained in the associated shelf 20 of the cabinet 15.

It is to be appreciated that although the display 30 in FIGS. 1 and 4 is depicted as a component of the POS device 45, any display device, such as display 110 (FIG. 3) or that provided by a touch screen display, a laptop, a smart phone, tablet, etc., such as (remote) computer 250, and in communications, wired or wirelessly, with the processor 100 may be used to provide the virtual storage arrangement 122 of the GUI 35 actively displayed with the visible indicator 200. It is further to be appreciated that the virtual storage arrangement 122 actively displayed with the visible indicator 200 (which can be shown also as a constant image, flashing image, spinning image, shaking image, and the likes) helps guide a clerk to the physical location of the one or more items 90 selected. Accordingly, it is to be further appreciated that in an embodiment, the user input device 125 can be a touch screen display and after electronic selection of the one or more items 90 via the touch screen display, the processor 100 activates the subset of lights 115 and displays the virtual storage arrangement 122 of the GUI 35 on the touch screen display with the visible indicator 135. In other embodiment, the entry device 130 is the POS device 45 and after electronic selection of the one or more items 90 via the POS device 45 and/or user interface device 125, the processor 100 activates the subset of lights 115 and displays the virtual storage arrangement 122 of the GUI 35 on the display 30 of the POS 45 with the visible indicator 135. In still another embodiment, the entry device 130 is the user input device 120 that is in communications with the point-of-sale (POS) device 45 and/or the processor 100, and after electronic selection of the one or more items 90 via the user input device, the processor 100 activates the subset of lights 115 and displays the virtual storage arrangement 122 of the GUI 35 with the visible indicator 135 on display 110.

In still another embodiment, after electronic selection of the one or more items 90, branding information 205 (FIG. 4) of the one or more items 90 can be displayed by the processor 100 on display 30, 110. For example, the branding information 205 of the one or more items 90 is a brand of tobacco. In still another embodiment, the processor 100 can display alternative information 210 of various products if the one or more items 90 selected are out of stock or the other various products are specifically marked for a promotion. In yet other embodiment, the processor 100 provides the GUI 35 as an interstitial or modal window via an Application Programming Interface (API) to a remote application 215. As depicted by FIG. 4, the GUI 35, when provided as an interstitial or modal window, overlays/pop-ups/sits on top of the graphical interface of the remote application 215 running, e.g., on the POS device 45. In still other embodiments, the processor 100 provides dispensing and replenishment balances 220 of the items 90 held by bins 80 of each shelf 20 in the cabinet 15 in response to queries received via the API from the remote application 215. In one embodiment, the remote application 215 is a conventional point-of-sale application, and in other embodiments it may be any suitable accounting, inventory management, ecommerce, and/or sales software application.

It is to be appreciated that in order to provide the GUI 35 on a display of a third party POS device 45 such integration is dependent on the capabilities of the host POS system. Some POS systems provide APIs in the form of one or more of the following: dynamically-linked libraries (DLL), Microsoft .NET assemblies, Component Object Model (COM) DLLs, XML interfaces, web services, SOAP or other service-oriented architectures (SOA), SQL databases, and so on. Some implementations may employ several of these methods at once, for example, when retrieving inventory data from a SQL database, while submitting credit card payment requests through an API or a XML request. According to the various disclosed embodiments of the present invention, the ability to provide the GUI 35 as an interstitial or modal window as illustrated in FIG. 4, via an available API, allows the information of the LIME system 10 to be displayed on multiple POS systems, while leaving the underlining POS framework/software unchanged.

Referring back to FIG. 3, upon the processor 100 subsequently receiving a detection signal from a sensor 95 of an associated bin 80 (with its subset of lights 115 lit/activated by the processor) of a quantity of items 90 placed or removed therefrom, the processor 100 records in memory 160 and/or 165 such in an event record 225. In particular, the processor 100 records automatically in the event record 225: the product identification 190 related to the one or more items 90 selected, a type of action 230 that is took place for each related item 90 selected, either a placement or a removal, a timestamp 235 of the date and time of the action, and/or a quantity 240 of the related items 90 detected by the sensor 95 as being placed or removed from the associated bin 80 having the subset of lights 115 lit and indicated in the detection signal. Optionally, the employee identification 185 performing the action 136 may also be included in the event record 132 if entry is requested by the processor 100 in order to accept the request for an item 90. In the above processing, should the processor 100 receive a detection signal from a sensor 95 that is not associated with the bin 80 of the one or more selected items 90 with the lit subset of lights 115, the processor 100 will then provide an error condition which will cause an alert that the one or more selected items 90 is being placed or removed to/from an incorrect bin 80. The error condition will continue until the sensor 95 of the incorrect bin 80 provides a detection signal of the placement or removal of the incorrectly picked or placed item as well as a detection signal of the placement or removal of the selected item 90 from the correct bin 80. It is to be appreciated that via the above mentioned configuration of the controller 65, the LIME system 10 helps to combat inventory shrinkage at least at the stocking and picking phase by tracking each placement and picking of an item 90 down to the level of each bin 80 at each storage location, such as in cabinet 15.

In still other embodiment, the processor 100 can transmit at regular intervals locally captured data, such as provided in records 225, to a centralized data warehouse 245 and/or to another remotely located (remote) computer 250 that is in communication with the controller 65 of the LIME system 10 (FIG. 1) via network 110 via the communications interface 105. In still other embodiments, one or more controller 65a, 65b of other LIME systems at other remote/geographically diverse locations may likewise be in communication with the centralized data warehouse 245 and/or remote computer 250 for monitoring sales and inventory in (near-) real time, thereby providing live tracking of the items contained in each shelf at each remote location over a geographic area/territory. In some embodiments, the network 110 is implemented using a wide area network (WAN) or other networking means such as an intranet or the Internet. As such, the centralized data warehouse 245 and remote computer 250 may include digital systems and other devices permitting connection to and navigation of the network 110 as well as to configure and control operation of each controller 65, 65a and 65b connected to the network 110.

As noted in the above description related to FIGS. 1-4, various electronic components in the LIME system 10 are in communication with other electronic components, which can be implemented via any medium that is capable of transmitting and/or receiving a data signal with one another such as, for example, via conductive wires, conductive traces, optical waveguides, electromagnetic signals, and the like. As also noted above, the controller 65 includes memory 160 and/or 165 as one or more memory component. One or more of such memory components may be a non-transitory computer readable medium or non-transitory computer readable memory and may be configured as a nonvolatile computer readable medium. One or more of such memory component also may comprise RAM, ROM, flash memories, hard drives, or any device capable of storing machine readable instructions, such as provided by software application 180, such that the machine readable instructions can be accessed and executed by the processor 100. The machine readable instructions may comprise logic or algorithm(s) written in any programming language such as, for example, machine language that may be directly executed by the processor, or assembly language, object-oriented programming (OOP), scripting languages, microcode, etc., that may be compiled or assembled into machine readable instructions and stored on such memory components. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. In the herein disclosed embodiments, the processor 100 is communicatively coupled to one or more such memory components that stores instructions, such as provided by software application 180, that when executed by the processor 100, cause the processor to perform one or more functions as described herein.

Generally, the software application 180 allows a user, such as a clerk, to view, add and subtract a number of physical items 90 associated with a bin of a shelf 155 virtually shown on a display 30, 110. The software application 180 indicates, by way of causing the processor 100 to illuminate the subset of lights 115 associated with the bin 80 of a selected item 90, e.g., a particular brand of tobacco or other FMCG from a shelf 20 of similar looking items. The software application 180 indicates, by way of an electronic illustration, i.e., GUI 35, and optionally presented as an interstitial or modal window, the position of a selected item 90 from the associated bin 80 on a display 110, after selection of the same via the user input device 125 or POS device 45, via the visible indicator 200. In further embodiments, the software application 180 indicates, by way of the GUI 35 as an interstitial or modal window, the bin 80 of the selected item 90, after selection on a display of a compatible third party point-of-sale device, such as POS device 45, e.g., being a PC-enabled cash register, with display 30.

In other examples, the software application 180, via the detection signal from the sensor 95, captures and counts incidences of items pulled from (e.g., for the purpose of sale) and inserted into (e.g., for the purpose of restock and replenishment) an associated bin 80. The detection signal may be sent by any conventional shelf pick and place detection device, such as e.g., and not limited thereto, time-of-flight sensors 95b, as well as by way of RFID reader(s)/antenna(s) (not shown) situated below or next to each stack of tobacco or FMCG. Such a shelf pick and place RFID based detection device is disclosed by U.S. Pat. No. 9,374,139, the disclosure of which is herein incorporated fully by reference.

In other embodiments, the software application 180 provides a utility that displays a cross-selling suggestion(s), i.e., via the alternative information 210, of one or more products if certain criteria such as, e.g., the originally selected product is out of stock or specifically marked for promotion. The software application 180 in another embodiment provides an API to third party point-of-sale integrators to allow for the display of the on-screen product pathfinding on such various systems, such as the POS device 45. Additionally, the software application 180 in another embodiment will provide an API to third party point-of-sale integrators to allow an embedded computing device, such as controller 65, to be queried to obtain dispensing and replenishment balances and other forms of on-site business intelligence.

The software application 180 also in another embodiment transmits at regular intervals locally captured data, such as records 225, to the centralized data warehouse 245 and/or computer 250 for aggregation of data, which may include like data from controllers 65a, 65b of other LIME system 10 installations, which may be used for business intelligence purposes by parties interested, e.g., in the various deployments of cabinets 15 and shelves 20, individually or together. In still a further embodiment, the software application 180 provides extensions to an internet-based portal to allow for the visualization, e.g., on computer 250 of the business intelligence provided by various installed controllers 65, 65a, and/or 65b.

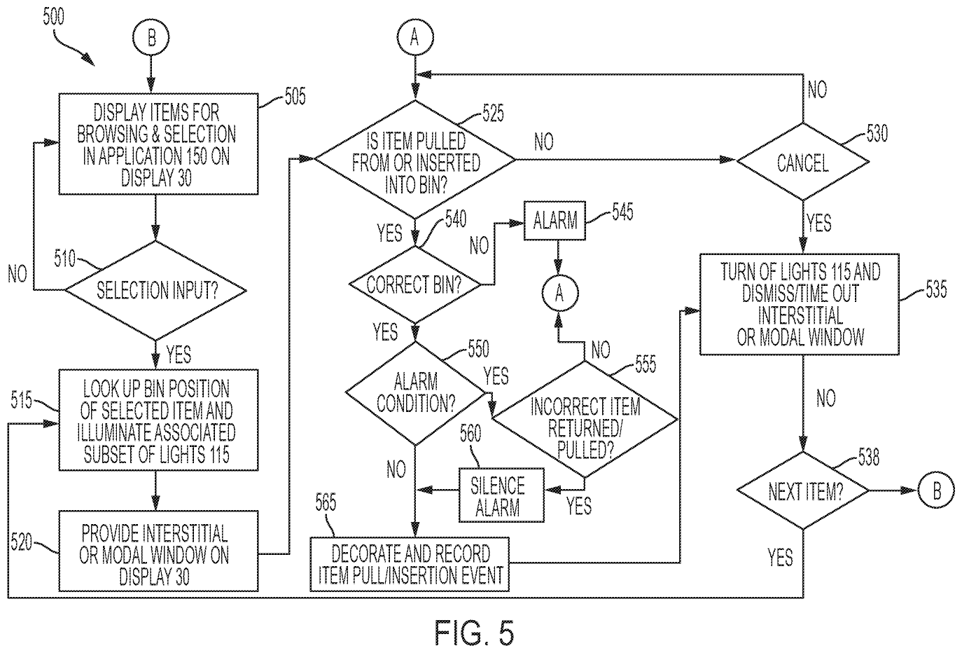

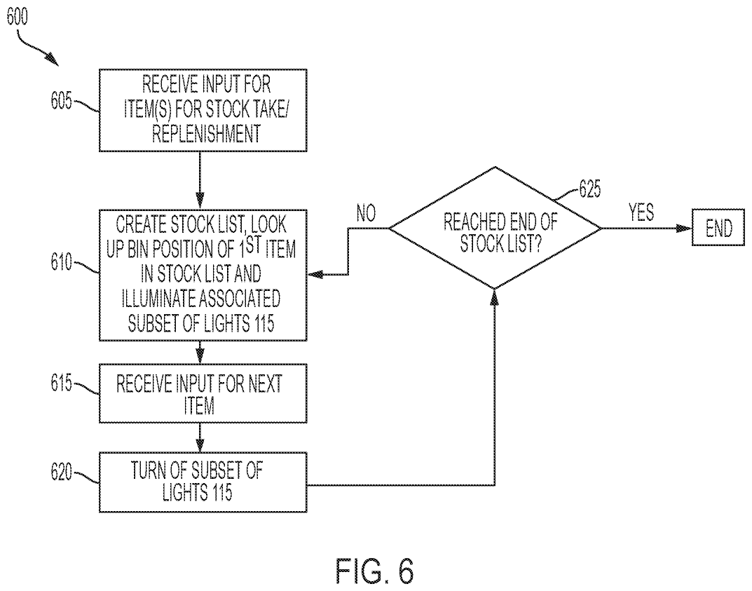

According to the above mentioned embodiments, the functions performed by one or more of the components/entities of the LIME system 10, such as all or portions of the controller 65, may be performed by various means, such as hardware and/or firmware, including those described above, alone and/or under control of the software application 180. As such, the software application 180 may be part of a computer program product for performing one or more functions of exemplary embodiments of the present invention. This computer program product may include a computer-readable storage medium, such as the non-volatile storage medium, and software including computer-readable program code portions, such as a series of computer instructions, embodied in the computer-readable storage medium. In this regard, FIGS. 5-6 are flowcharts of apparatuses, methods and program products according to exemplary embodiments of the present invention.

It will be understood that each step or block of the flowcharts, and combinations of blocks in the flowcharts, depicted by FIGS. 5 and 6 can be implemented by various means, such as hardware, firmware, and/or software including one or more computer program instructions. As will be appreciated, any such computer program instructions may be loaded onto a computer or other programmable apparatus, such as processor 100, to produce a specific machine, such that the instructions which execute on processor, the computer or other programmable apparatus (i.e., hardware) create means for implementing the functions specified in the step(s) or block(s) of the flowcharts. As mentioned, these computer program instructions may also be stored in a computer-readable memory that can direct a computer or other programmable apparatus to function in a particular manner, such that the instructions stored in the computer-readable memory produce an article of manufacture including instruction means which implement the function specified in the step(s) or block(s) of the flowcharts. The computer program instructions may also be loaded onto a computer or other programmable apparatus to cause a series of operational steps to be performed on the computer or other programmable apparatus to produce a computer-implemented process such that the instructions which execute on the processor, computer or other programmable apparatus provide steps for implementing the functions specified in the step(s) or block(s) of the flowcharts.

Accordingly, steps or blocks of the flowcharts depicted by FIGS. 5 and 6 support combinations of means for performing the specified functions, combinations of steps for performing the specified functions and program instruction means for performing the specified functions. It will also be understood that one or more steps or blocks of the flowcharts, and combinations of steps or blocks in the flowcharts, can be implemented by special purpose hardware-based computer systems which perform the specified functions or steps, or combinations of special purpose hardware and computer instructions.

With reference to FIG. 5, depicted is a flowchart of machine logical processes/programming of a selection workflow 500 implemented by the LIME system of FIG. 1 according to an embodiment thereof. In block 505 of the selection workflow 500, the processor 100 is running/providing on display 30, 110 the software application 180 which permits a user to browse virtually the various items/products contained in the cabinet 15 and select one or more items 90 (different and/or same) therefrom via the user input device 125. After a selection input is received via the user input device 125, which is checked in block 510, the processor 100 will look up the information 140 related to the selected item 90 to determine the associated bin 80 and illuminate the associated subset of lights 115 in block 515.

In block 520 of FIG. 5, the processor 100 then opens an interstitial or modal window on display 30, 110 which highlights the position of the associated bin 80 currently being illuminated by the lit subset of lights 115 via the visible indicator (position indicating icon) 200 (FIGS. 1 and 4). In block 525, the processor 100 then waits for a signal from sensor 95 which will indicate whether a product e.g., item 90, is pulled from or inserted directly into the associated bin 80. While waiting, in block 530, the processor 100 checks to see if the selection has been cancelled via a cancel selection 255 (FIG. 4) provided on the GUI 35 and/or user input device 125 (not shown). If an item selection is cancelled, then the processor 100 turns off the subset of lights 115 and dismisses/permits the timing out the interstitial or modal window in block 535. In block 538, if there is not a next item, then the processor 100 will return to block 505 to wait for an input of a product browsing and/or selecting via the user input device 125. If, however, there is another item that had been selected, then the processor 100 will return to block 515 to look up the information 140 related to the next selected item 90 to determine the associated bin 80 and illuminate the associated subset of lights 115.

Upon receiving the signal from the sensor 95 in block 525, the processor 100 will check in block 540 whether the signal indicating the pulled or placement of an item is from the correctly associated bin 80 for the selected item 90. If not, then the processor 100 will set an alarm condition in block 545 which provides an alarm, e.g., a warning sound from speaker/blue tooth device 120 (FIG. 3) and/or an error message 260 (FIG. 4) provided on display 30, 110, and return to block 525 to wait for a signal from the sensor 95 of return and removal of the incorrect item and/or a pulling and/or placement of the selected item 90. After receiving the above sensor signal(s), and if in block 540 the received signal from the sensor 95 indicants that the detected pull or placement is from the correct bin of the selected item 90, the processor 100 in block 550 will check if an alarm condition has been set. If the alarm condition was previously set, then the processor 100 will check in block 555 to see if a signal was provided via an associated sensor in block 525 as to whether the incorrectly picked or placed item was returned to/removed from the incorrect bin. If not, then the processor 100 continues the alarm/error message display and returns to block 525 for such a signal indicating that the incorrect item has been replaced or removed in order to clear the alarm condition and silence the alarm/error message in block 560.

When not in or no longer in an alarm condition as determined by block 550, the processor 100 will then in block 565 decorate the associated bin 80 with a success condition via flashing, i.e., quickly turning on and off the subset of lights 115 for a short period of time, e.g., less than 5-10 seconds, and record a pulling or insertion event for the selected item in the event record 225 and/or in an associated database record of the POS device 35, data warehouse 245, and/or computer 250. Next, the processor 100 will proceed to block 535 to carry out the processes of turning off the subset of lights 115 and dismiss/time out the interstitial or modal window. The processor 100 continues with the check in block 538, and if no further items have been selected, returns to block 505 to repeat the process upon a new selection input.

Turning now to FIG. 6, depicted is a flowchart of the machine processes of a stock take/replenishment workflow 600 implemented by the LIME system 10 of FIG. 1 according to an embodiment thereof. In block 605 of the stock take/replenishment workflow 600, upon launching the stock take/replenishment feature of the software application 180, the processor 100 waits for input of a selected item(s) 90 for stock take/replenishment via user input device 125. It is to be appreciated that one or more items 90, including all items in the cabinet 15, may be selected to form a list of items selected, inputted and operated upon by the processor 100. After receiving the input in block 605, the processor 100 in block 610 will illuminate a bin 80 that corresponds to a first one of the selected items(s) 90 via the corresponding subset of lights 115. The user then proceeds to stock take/replenish the illuminated bin 80. While the user is in the process of the stock take/replenishment of the illuminated bin 80, the processor 100 waits to receive a next item input via the user input device 125 in block 615. After receiving the next item input in block 615, the processor in block 620 turns off the lit subset of lights 115, and then in block 625 checks whether there is another item, e.g. in the list of items selected in block 605. If there is another item, then the processor proceeds back to block 610 and illuminates the next bin 80 via the associated subset of lights 115 for the next item that is to be processed by the stock take/replenishing steps. If in block 625 there is not a next item, then the processor 100 will end the stock take/replenishment workflow 600.

By the above disclosure, a method for dispensing items from the LIME system 10 is realized. The LIME system 10 in an embodiment comprises a shelf 20 having a plurality of dividers 85 which divide the shelf 20 into a plurality of bins 80 for holding visibly identifiable items 90. A sensor 95 associated with each one of the plurality of bins 80 to detect placement or removal of one or more of the items 90 from the associated bin. A processor 100, having a memory 160, 165 which stores an item list 170 indicating which items 90 are held within each of the bins 80 and being in communication with the sensor 95, receives a detection signal which indicates the placement or removal of one or more items from the associated bin. An entry device 130 in communication with the processor 100, sends entered requests for placement or removal of the one or more items 90 to the processor. An indicator strip 25 attached to the shelf 20 has a set of lights 30 linearly arranged in an single dimension such that an associated subset of lights 115 thereof comprising two or more lights uniquely identifies one of the bins 80 when lit. The indicator strip 25 is in communication with the processor 100 and wherein the processor further includes information 140 relating to which bin 80 each subset of lights 115 is associated, and wherein selection of at least one of the items 90 from the item list 170 via the entry device 130 causes the processor 100 to send a signal to actuate the subset of lights 115 that is associated with the bin 80 with the one or more items selected. The processor 100 records in memory 160, 165 a type of action 230 being selected from a placement and a removal, a timestamp 235 and a quantity 240 of the one or more items selected placed or removed from the associated bin 80 having the subset of lights 115 lit and indicated in the detection signal subsequently received from the sensor 95 of the associated bin 80.

With the above noted LIME system embodiment in mind, one or more methods have been disclosed. For example, in an embodiment, the method may comprise storing in memory 160, 165 an item list 170 of the items 90 which are held within each of the bins 80, and information 140 relating to which bin 80 each subset of lights 115 of the strip 25 is associated with each item 90. Such methods may further comprise one or more of the following steps of: receiving via the processor 100 entered requests for placement or removal of one or more selected items 90 sent from the entry device 130 to the processor; sending via the processor 100 a signal to actuate the subset of lights 115 which is associated with the bin 80 with the one or more selected items 90; and recording in memory 160, 165 the type of action 230 selected from a placement and a removal, the timestamp 235 and the quantity 240 of the one or more selected items 90 placed or removed from the associated bin having the subset of the set of lights light and indicated in a detection signal subsequently received from the sensor of the associated bin.

In still other embodiments, one or more methods may include also recording in memory 160, 165, the product identification 190. In other embodiments, one or more methods may comprise: entering employee identification 185, and verifying the entered employee identification is as an authorized employee before permitting the processor 100 to accept a selection of the one or more items 90. In other embodiments, the method may comprise sending, via the processor 100, a signal to unlock a lock 60 of a cabinet 15 containing the one or more items 90 selected, and in which in other embodiments entered employee identification 185 is first verified by the processor 100 as an authorized employee before permitting the processor to accept a selection of the one or more items and/or send the signal to unlock the cabinet containing the one or more items selected.

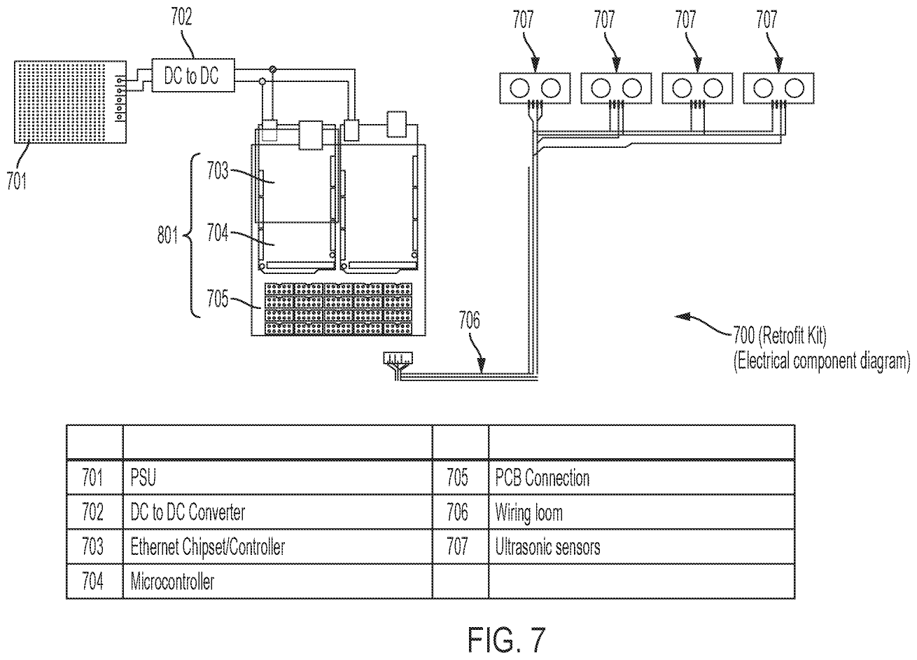

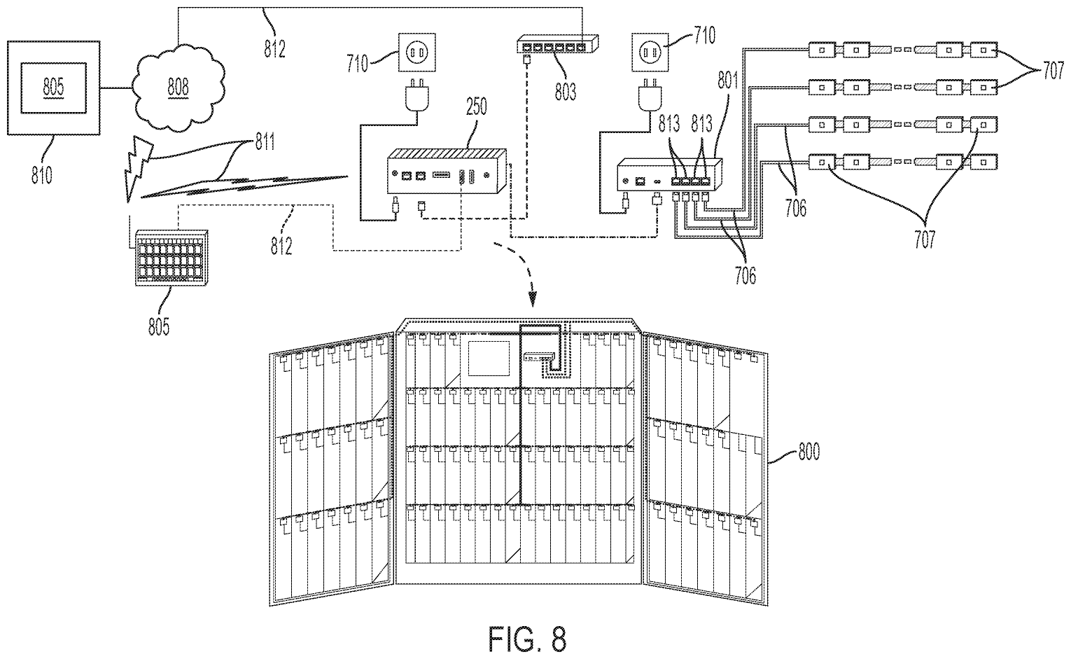

In still other embodiments, the LIME system 10 may be implemented as a retrofit kit, hereinafter the VDMS Inventory Management System (VIMS) retrofit kit. FIGS. 7 and 8 show generally the electrical components of the retrofit kit according to two illustrated embodiments. The VIMS retrofit kit 700 equips and facilities measurements of the product inventory held inside a commercially available, legacy vending machine previously without such a capability. Once such a legacy (non-network capable) vending machine is retrofitted with the VIMS refit kit 700, product level in each bin of the vending machine is detected and displayed remotely over a network on a display, such as a touch screen, of a supplier. This enables the supplier to visually see when such a retrofitted machine needs to be replenished. In addition, collected data from the retrofitted machine is used in a report function provided by the VIMS retrofit kit 700, which the supplier may use to review and print a report to assist with the replenishment process.

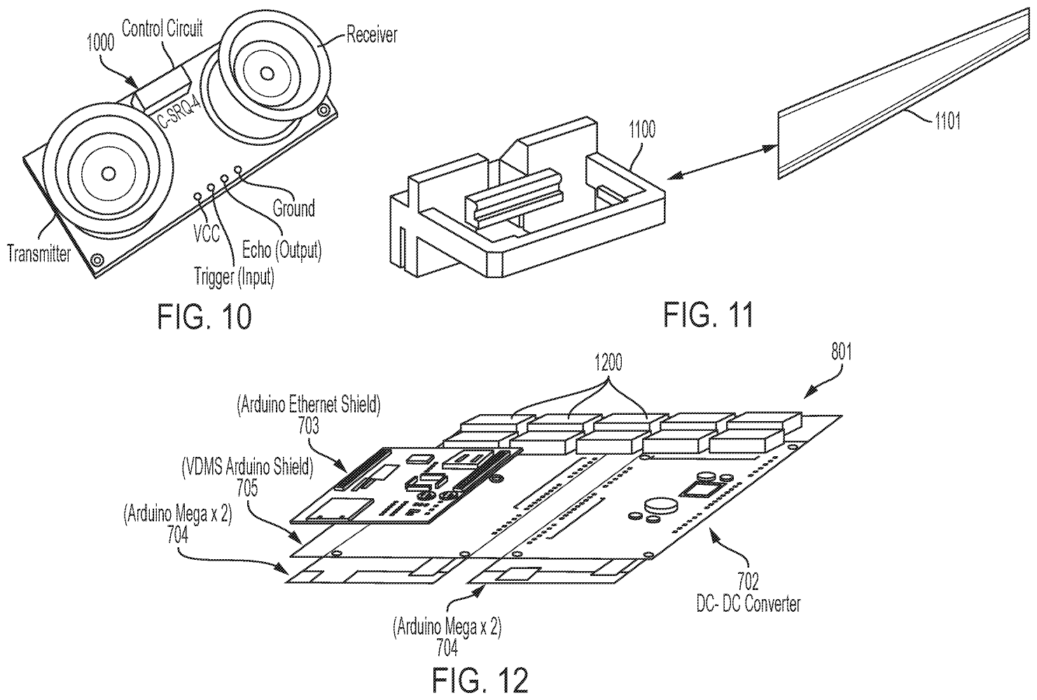

The VIMS retrofit kit 700 in the illustrated embodiment of FIG. 7 uses a Time-of-Flight (TOF) detection of a sensor 707 to determine distance to an object, such a product in a bin of a vending machine, such as in one embodiment via an ultrasonic transmitter and receiver modules 1000 (FIG. 10). This arrangement offers excellent non-contact range detection with high accuracy and stable readings in an easy-to-use package. The other electrical components of the retrofit kit depicted in FIG. 7 generally are a power supply unit 701, such as one from Harting, Elgin, Ill., and a DC to DC converter 702, an Ethernet chipset 703, a microcontroller 704, a PCB connector board 705, and a wiring loom 706.

It is to be appreciated that in other embodiments, the kit 700 may use another type of Time-of-Flight (TOF) sensor 707, such as the VL53L0X laser-ranging module from STMicroelectronics (Geneva, Switzerland). In such an embodiment, TOF detection up to 2 meters is achievable independent of target reflectance with repeatable results. This type of sensor 707 has been found to be useful with many of the various types of pushers utilized in existing/conventional “legacy” vending machines in which each wiring loom 706 may then have up to 256 electrically connected sensors 707 each providing TOF data to the microcontroller 704. The other electrical components of the retrofit kit 700 may also vary from the illustrated embodiment depicted in FIG. 7, such as e.g., the power supply unit 701 may be one from the STM32F0xxxx product family from STMicroelectronics (Geneva, Switzerland), which provides an integrated DC to DC voltage converter in order to power the TOF sensors 707. In addition, the microcontroller 704 used for ultrasonic based TOF sensors may be a Mega 2560 unit from Arduino (Somerville, Mass.) and for laser based TOF sensors may be one from the STM32L433xx product family from STMicroelectronics (Geneva, Switzerland), which may provide integrated therewith Ethernet chipset 703. Further integration of an additional one or more of the above components into an ASIC may also be used.

As depicted, the TOF sensors 707 may be mounted on a PCB board (e.g., 20 mm×45 mm) individually and connected to each other in a multi-channel, daisy-chained fashion via wiring loom 706. In other embodiments, two or more TOF sensors 707, and preferably versions with 4 and 5 sensors each, may be mounted to a single PCB board to form a sensor strip, which sensor strips are then connected to each other in a daisy-chain fashion via multiple wire looms 706. In other embodiments of FIG. 7, the communication link between at least the sensors 707 and microcontroller 704 may be implemented using for the wire looms 706 a Universal Series Bus, a wired bus having transmitters, receivers, and/or transceivers that follow the RS-485 or RS-422 wired communication standards published by the Telecommunications Industry Association/Electronic Industries Alliance (TIA/EIA), and the like.

Turning now to FIG. 8, an overview of an installation of the kit 700 to retrofit an existing/conventional “legacy” vending machine 800 which did not have an electronic based live inventory/product level sensing means is provided. The Ethernet chipset 703, the microcontroller 704, and the PCB connector board 705 together form a controller 801, which via the chipset 703 connects the controller 801 to a network such as via a network switch or modem 803. In this manner, the controller 801 may process and send data collected via sensors 707 to a remote display, such as a touchscreen 805 (e.g., of computer 250), directly if locally located or over a network (e.g., a LAN, WAN, Internet, cellular and/or satellite based) 808 (110) (wirelessly 811 or wired 812) if remotely located as well as to any number of such computers communicatively connected over the network 808, e.g., in the cloud, for supply chain monitoring and management. In the illustrated embodiment of FIG. 8, the computer 250 and the controller 801 plug into a conventional AC line voltage socket 710 e.g., providing 112V/240V, and convert such voltage to the necessary DC voltage to operate themselves and any connected components, such as for example, sensors 707.

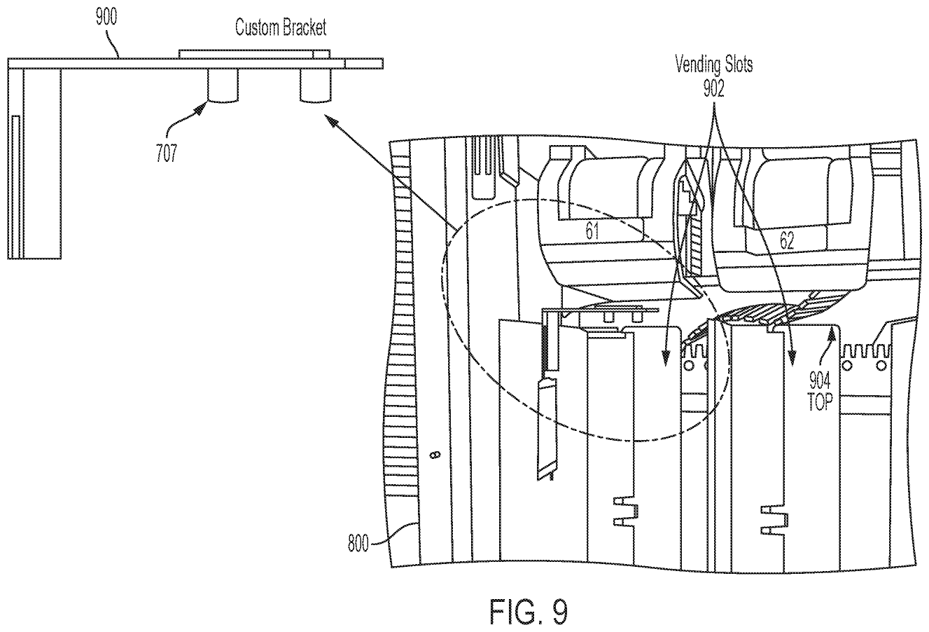

As depicted by FIG. 9, one or more custom brackets 900 are provided in the retrofit kit 700 for easy installation of the sensor 707 in each vending slot 902, e.g., by mounting one or more of the brackets 900 at or adjacent a top 904 of each slot, in a machine with vertically arranged slots 902 or at the back/backwall 72 (FIG. 1) of horizontally arranged slots 80 (FIG. 1). All sensors 707 are installed mounted at the same height in the vending machine 800, so information delivered by each unit is consistent and accurate.

FIG. 10 depicts an illustrative embodiment of a suitable type of ultrasonic sensor 1000 for sensor 707, e.g., an HC-SR04 ultrasonic sensor, which has the following features noted in Table 1.

TABLE 1
Features:

Power Supply: +5 V DC
Quiescent Current: <2 mA
Working Current: 15 mA
Effectual Angle: <15°
Resolution: 0.3 cm
Measuring Angle: 30 degree
Trigger Input Pulse width: 10 μS
Dimension: 45 mm × 20 mm × 15 mm

The sensor 1000 provides range of 2 cm-400 cm for non-contact measurement, with a ranging accuracy of about 3 mm. The sensor 1000 includes an ultrasonic transmitter, receiver and control circuit. For each sensor (e.g., sensor 95b, 707, 1000), a sensor bracket 1100 depicted by FIG. 11 may be provided in order to mount the sensor easily in the vending slot 902. It is to be appreciated that other types of vending slot sensor brackets may likewise be provided depending on the type of sensor 707 employed in the kit 700 and dimensions of each slot 902 in the vending machine 800. In addition, to make the installation process simply as possible, a support bracket 1101 may be provided in which multiple sensor brackets 1100 with their associated sensor are slide into to be accommodated/mounted therein and all together be installed on the back each shelve 20 (row and/or column) of the machine 800.

All sensors 707 are connected electrically to the controller 801 via a wiring loom 706 (FIG. 8). The controller 801 comprises a microcontroller with digital input/output ports, an oscillator, a USB connection, a power jack, an ICSP header, and a reset button. As mentioned previously above, the controller 801 also includes an Ethernet chipset 703, such that the microcontroller 704 may connect to a network, e.g., the Internet, a LAN and/or WAN via computer 250 (as illustrated in FIG. 8) and/or switch 803. The DC to DC converter 702 is also provide to convert the vending machine's native power supply, e.g. from 12/24V to 5.7V and supplied by residential AC power, to power the controller 801. Various customized board connector placements and connectors 1200 (FIG. 12) are provided to simplify sensor 707 connection thereto once installed into a respective vending slot 902.

In one illustrated embodiment depicted by FIG. 12, the controller 801 is build using multiple hardware parts electrically connecter together. The parts in this illustrated embodiment are:
Dual microcontrollers 704;
an Ethernet chipset/controller 703;
a DC to DC converter 702; and
a PCB Connection board 705.

As mentioned previously above, the microcontroller 704 may be, e.g., a ATmega 2560 processor from Arduino (Somerville, Mass.) in one embodiment, or in another embodiment a STM32L433xx based microcontroller from STMicroelectronics (Geneva, Switzerland). In the above former embodiment, all sensors 707 are connected to separate ports on the microcontroller 704, and as the microcontroller in this embodiment operates only a limited amount of inputs and outputs, two (2) such microcontrollers 704 are connected electrically together on the PCB connection board 705 as a master/slave using the I2C protocol. However, in still other embodiments, especially in those employing a microcontroller with RS-485 or RS-422 based inputs/outputs, such as a STM32L433xx based microcontroller, the sensors 707 may be serially connected (daisy-chained) together up to the maximum permitted by the communication standard (e.g., up to 32 node devices using a RS-485 transmitter, and expanded by adding an isolated repeater for another 32 node devices to be connected) in order to reduce the number of port connections to the microcontroller. The microcontroller 704 in various embodiments also contains everything needed to support a connection to a computer, via a USB cable, and to power it with an AC-to-DC adapter or battery.

As an example, the microcontroller 704 for the ultrasonic based TOF sensors 707 may be based on the ATmega 2560 processor which has 54 digital input/output pins of which 15 can be used as PWM outputs, 16 as analog inputs, 4 as UARTs hardware serial ports, and also provides a 16 MHz crystal oscillator, a USB connection, a power jack, an ICSP header, and a reset button. A summary of the microcontroller features based on the ATmega 2560 processor are listed in Table 2:

TABLE 2
Specification:

Microcontroller: ATmega2560
Operating Voltage: 5 V
Input Voltage (recommended): 7-12 V
Input Voltage (limits): 6-20 V
Digital I/O Pins: 54 (of which 15 provide PWM output)
Analog Input Pins: 16
DC Current per I/O Pin: 40 mA
DC Current for 3.3 V Pin: 50 mA
Flash Memory: 256 KB of which 8 KB used by bootloader
SRAM: 8 KB
EEPROM: 4 KB
Clock Speed: 16 MHz

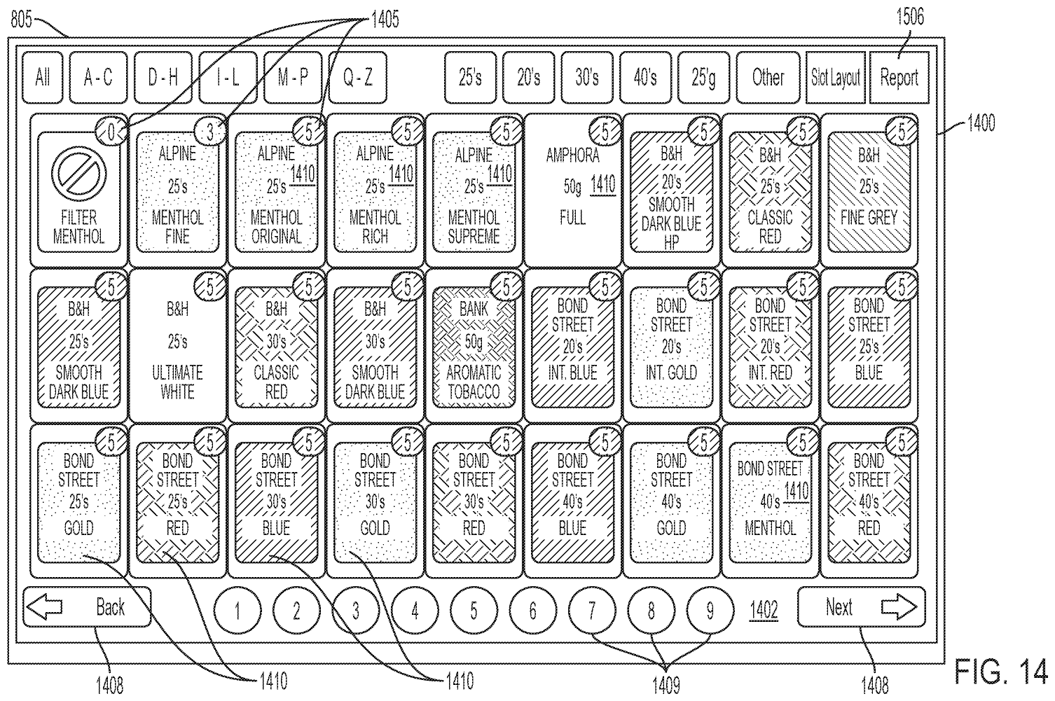

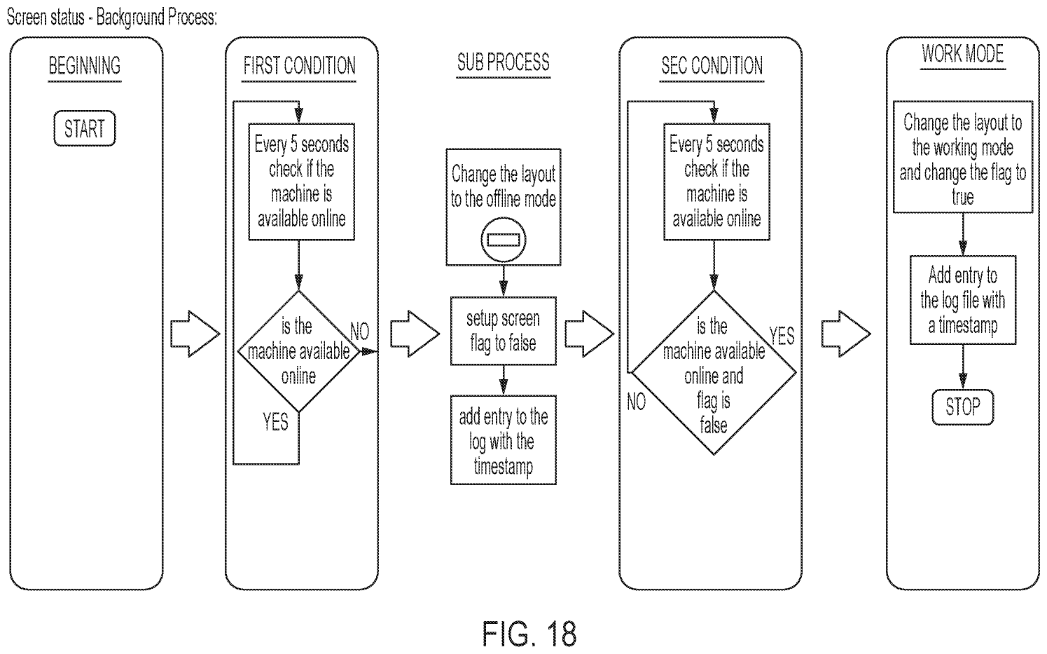

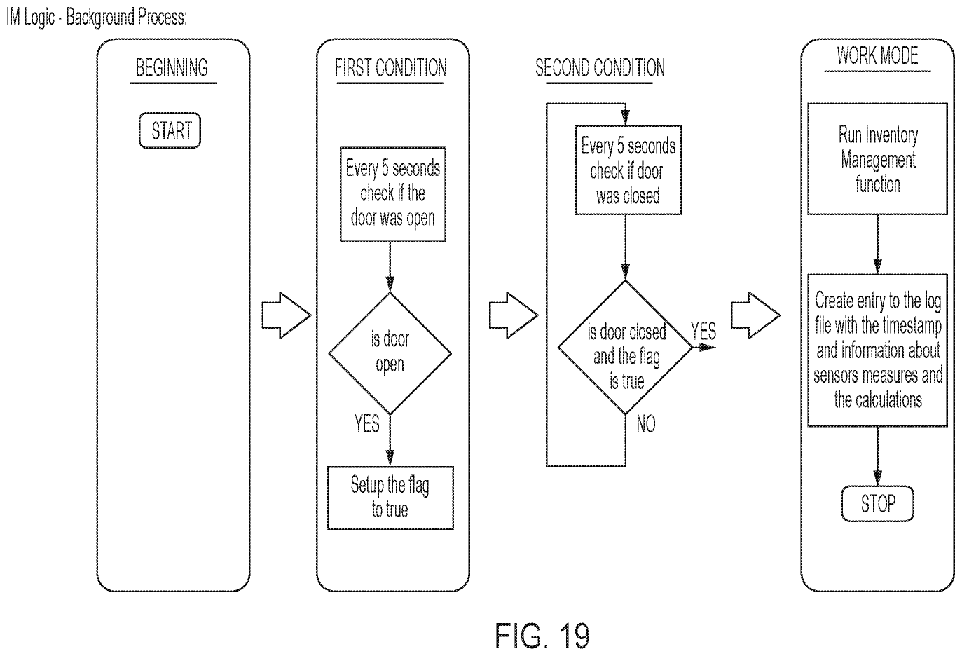

The Ethernet chipset/controller 703 in one embodiment, especially in the embodiment employing the ATmega 2560 processor, maybe, e.g., an Ethernet Shield from Arduine (Somerville, Mass.). The Ethernet chipset/controller 703 provides electrical communications from the controller to remote system components, such as to display touchscreen 805 and connects directly to the microcontroller 704 on a provided SPI port. The Ethernet chipset/controller 703 is based on the Wiznet W5500 Ethernet chip and has preconfigured individual IP address to connect the microcontroller 704 to the network 808 (110). The Ethernet chipset/controller 703 also provides a network (IP) stack capable of both TCP and UDP, and supports up to eight simultaneous socket connections. The Ethernet chipset/controller 703 uses an Ethernet library to write program code/functions (e.g., an http sketch) that enable accessing and using the data from microcontroller 704 in order to provide the features depicted by FIGS. 14-20. The Ethernet controller 703 connects to the board of the microcontroller 704 using long wire-wrap headers, thereby permitting stacking of another microcontroller 704 thereto. The Ethernet controller 703 has a standard RJ-45 connection, with an integrated line transformer and Power over Ethernet enabled. A provided onboard micro-SD card slot, which can be used to store files for serving over the network, is also accessible through program code/functions of the library. The Ethernet controller 703 also includes a reset controller, to ensure that the W5500 chip is properly reset on power-up. A summary of features for other suitable Ethernet controllers is listed in Table 3.

TABLE 3
Features:

IEEE802.3af compliant
Low output ripple and noise (100 mVpp)
Input voltage range 36 V to 57 V
Overload and short-circuit protection
9 V Output
High efficiency DC/DC converter: typ 75% @ 50% load
1500 V isolation (input to output)

The DC-DC converter 702 is used to connect to controller 801 to an existing power supply, such as provided by the machine's motherboard 802 (FIG. 8). To enable such, the DC-DC converter 702 steps down the vending machine's power supply from a typical 24V to 5.7V required by the microcontroller 704. A summary of features of other suitable converters is listed in Table 4.

TABLE 4
Specifications:

Regulator Type: Step Down (Non Isolated input to Output)
Input Voltage: +4 to 40 vdc
Output Voltage: +1.25 to 35 vdc
Output Current: 2A Rated, (3A maximum with heat sink)
Switching Frequency: 150 kHz
Efficiency: Up to 92% (when output voltage is set high)
Dropout Voltage: 2 vdc minimum
Load Regulation: +/−0.5%
Voltage Regulation: +/−2.5%
Temperature: −40 to +85 deg C. (output power less than 10 Watts)

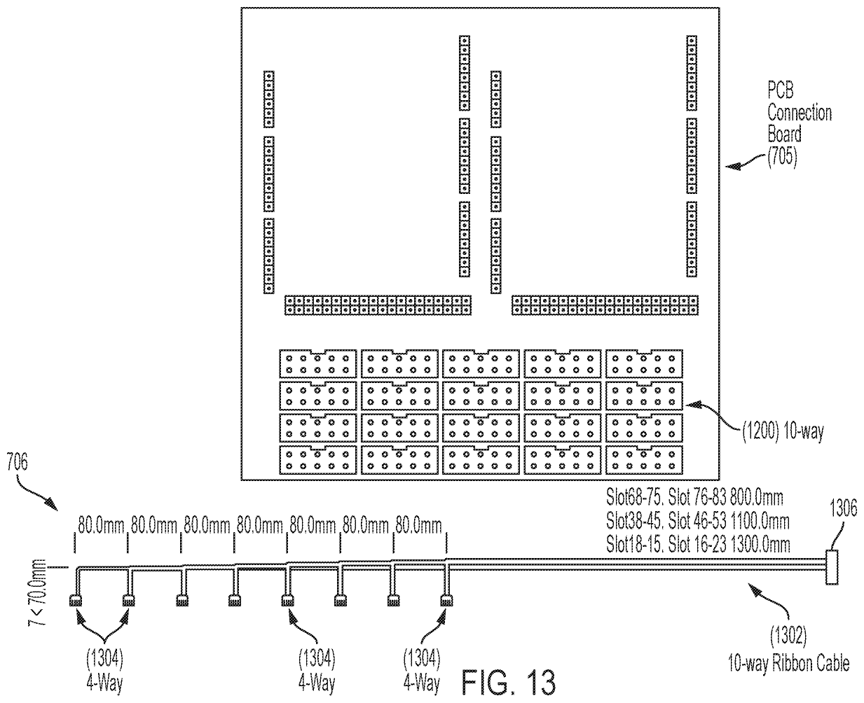

To eliminate problem with time consuming connections, the PCB connection board 705 provides an easy connection between all sensors 707/wiring looms 706 and components of the controller 801, i.e., the microcontroller, the Ethernet controller and the DC-DC converter. In the illustrated embodiment shown by FIG. 13, the wiring loom 706 at the ends of, e.g., a 10-way ribbon cable 1302, such as 10 Way Unscreened Flat Ribbon Cable, RS-Online: RS Stock No. 105-5281 Mfr. Part No. 3302-10 100FT, has 4-way connectors 1304 that are used to electrically connect to the one or more sensors 707, such as e.g., IDC Connector, Socket, 4 Way, 1 Row, RS-Online: RS Stock No. 189-9463 Mfr. Part No. 661004151922, and a 10-way connector 1306, such as IDC Connector, Socket, 10 Way, 2 Row, RS-Online: RS Stock No. 832-3617 Mfr. Part No. T812110A100CEU, which is used to connect electrically to a connector 1200 of the board 705. This way, a plurality of sensors 707 ranging from 1 to 8 may be connected per 10-way connector 1200 location on the board 705. In the illustrated embodiment of FIG. 13, 20 connectors 1200 thereby providing a 160 sensor connection limit.

In other embodiments, especially in embodiments of the controller 801 employing a STM32L433xx based microcontroller 704 with built-in RS-485 ports 813, such as depicted by FIG. 8, it is to be appreciated that the RS-485 standard does not specify the type of connector or pinouts. As such, the connectors may be DB9, DB25, Terminal Blocks, RJ11, RJ45, round DIN connectors, and the like in order to provide an electrical connection between the sensors 707 (typically up to 256 uniquely addressed sensors) and the microcontroller 704 in a network style configuration. It is to be appreciated that with more than 32 devices per line, repeaters and a converter(s) or interface card that has Automatic Send Data Control is likewise used in the RS-485 network.

In various embodiments, the controller 801 of the retrofit kit 700 implements two APIs: the VIMS API 808 that is installed as a program code in memory of the microcontroller 704 and the VENDGUI API 810 that is installed when the controller 801 is accessed and connected to the remote touchscreen 805 (FIG. 8), i.e. via browser 1400 (FIG. 14). In other embodiments, the VIMS API 810 may be installed on the computer 250 (e.g., FIG. 8) for providing the same functionality as the controller 801 either as a backup and/or as the primary component enabling such functionality. The VIMS API 808 delivers measures from all sensors 707 in JSON (JavaScript Object Notation) format straight away after a connection (e.g., via the browser 1400) from the touchscreen 805 is realized. After connecting with the touchscreen, the VIMS API 808 causes that microcontroller 704 to ping every sensor 707 and counting the respond times in microseconds “μS”, and then uses this value to calculate distance to the object. The respond time in microseconds“μS” is used to calculate distance to the object using the following formula: Distance=μS*0.034/2. Finally, all determined measurements are then converted to the JSON format for sending at least to touchscreen for display. A sample of message delivered by VIMS API in JSON format is as follows:
[{“SlotNumber”: “1”,“result”: “15.00”},{“SlotNumber”: “2”,“result”: “15.00”},
{“SlotNumber”: “3”,“result”: “15.00”},{“SlotNumber”: “4”,“result”: “15.00”}
. . .
{“SlotNumber”: “96”,“result”: “15.00”},{“SlotNumber”: “96”,“result”: “15.00”}]
Where:
SlotNumber—the slot number where measure was taken; and
result—result delivered in cm (accuracy to 2 points after decimal point).

The VENDGUI API 810 provides an easily way to notify a user via the display, e.g., touchscreen 805, about the number of each product 1410 in slot (bin, etc.) of the machine (cabinet, etc.). As depicted by FIG. 14, a special color code is used on webpage 1402 displayed by the browser 1400 on the display 805 of a computing device (45, 250), wherein if more than 4 products are in the machine, a Quantity (“Qty”) badge 1405 will be displayed in a first color, e.g. green, and if less than 4, the Qty badge 1405 changes the color to a second color, e.g., amber. If the product is OOS, then the Qty badge 1405 changes a third color, e.g., red. If the vending machine 800 has 2 or more slots (bins, etc.) with this same product, then VENDGUI API 810 will display on the display/touchscreen 805 a sum of products as measured by the controller 801. The products/items 1410 contained in the slots (bins, etc.) of the machine may be listed on the display 805 alphabetically as depicted along with a product name along with the detected Quantity badge 1405. Multiple ones of such a product webpage 1402 may be also accessed by using and selecting a provided navigation button 1408 and/or page selection button 1409.

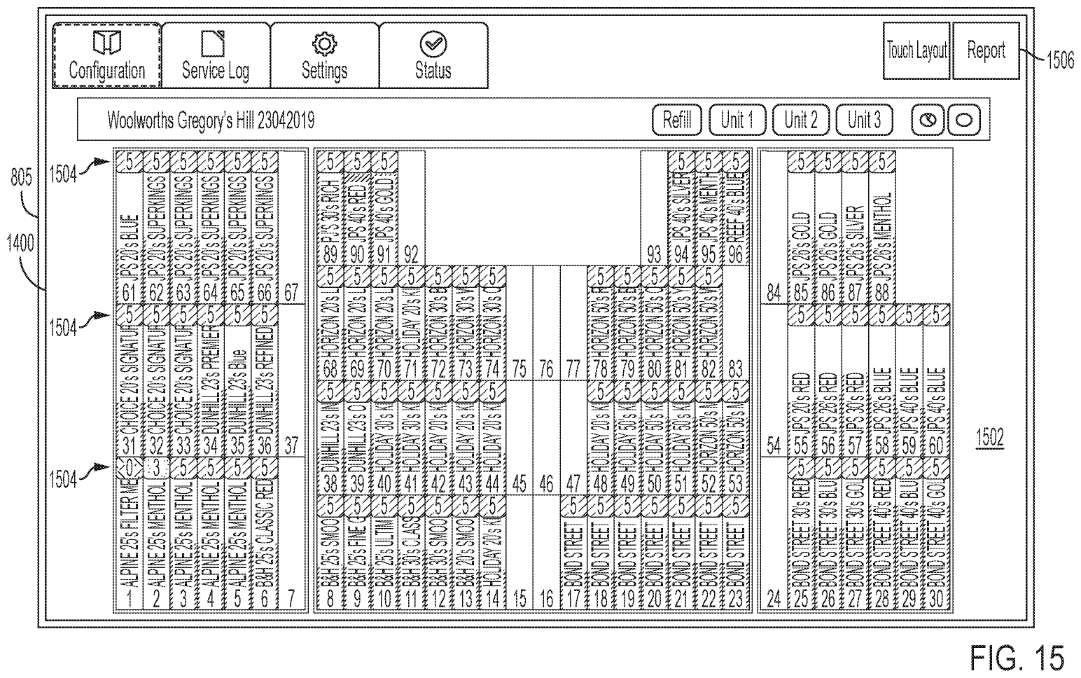

A slot layout display webpage 1502 is also accessible by the web browser 1400 for display on the display/touchscreen 805, which provides the number of products 1410 in each slot (bin, etc.) as a color bar 1504 across the planogram and as the number above each column as depicted by FIG. 15. The same color coding as disclosed above in reference to FIG. 14 is used. For example, a first color, e.g. green is shown if the slot (bin, etc.) has more than 4 products 1410, a second color, e.g. amber is shown if slot (bin, etc.) has less than 4 products 1410, and a third color, e.g. red shows if a product 1410 is out of stock (OOS).

From any of the webpages 1402, 1502, a product status report may be emailed, e.g., to a designated email address such as to a site manager, via a report button 1506. Reporting information may include, for example: max of each product in the machine, real time availability, how many products have to be fill in to keep the machine full and how many cartons have to be taken from the office to not leave single packs free. For example, in the use case of a cigarette vending machine, e.g., machine 800 retrofitted with the above disclosed kit 700, to calculate cartons, the following quantity formula is used:
20's, 23's (Winfield Jets only)—10 products per carton
23's (Dunhill) 25's, 26's—8 products per carton
30's 35's—7 products per carton
40's—5 products per carton
50's—4 products per carton
52's, 60's—3 products per carton
80's, 90's—2 products per carton
All RYO—5 products per carton

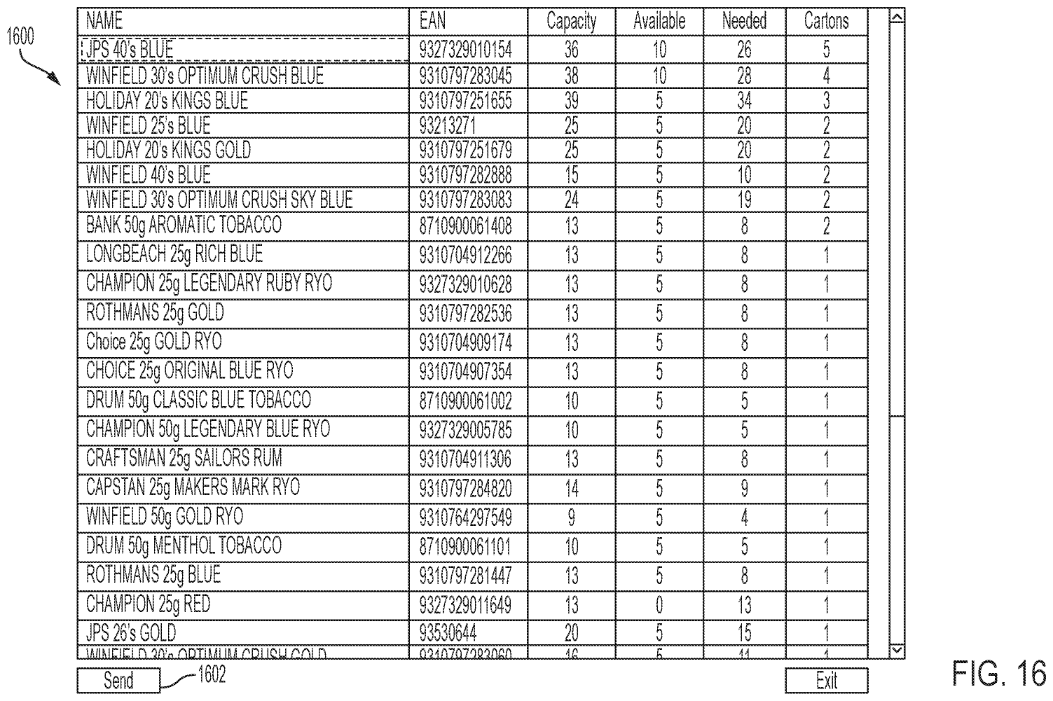

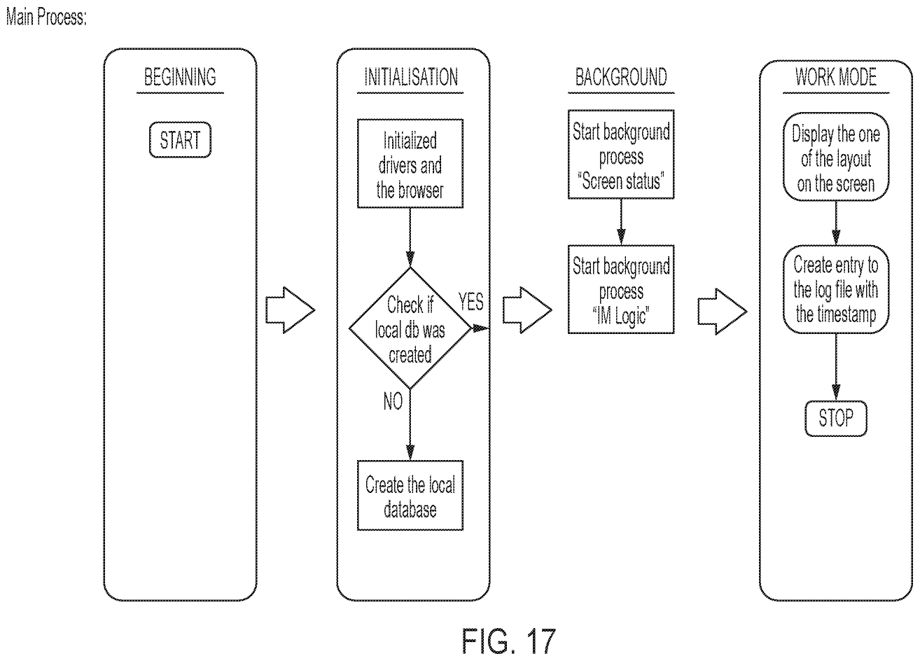

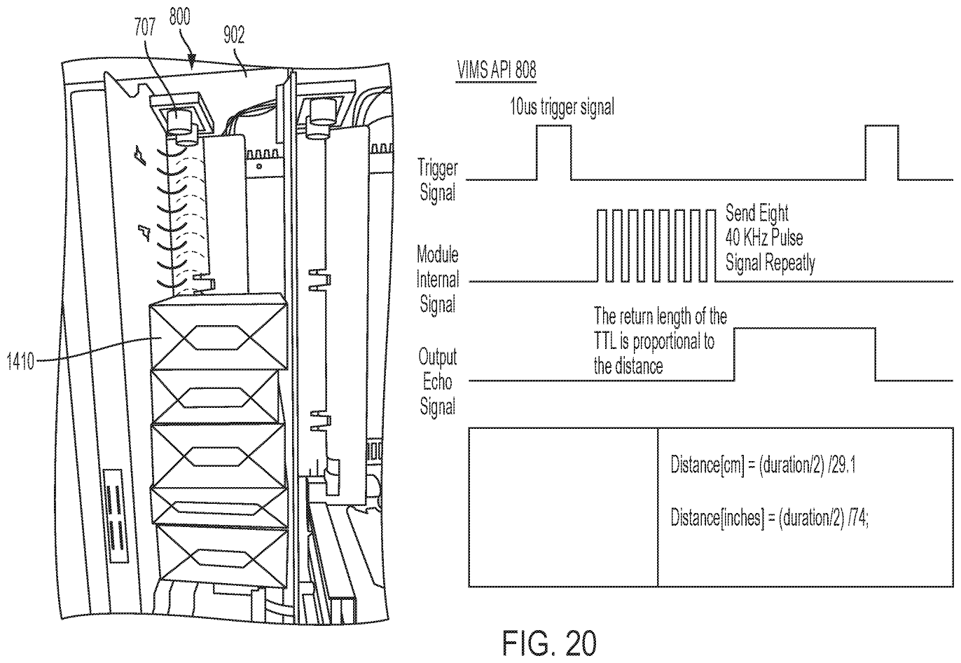

A sample report 1600 that may be displayed first on display first and then emailed via, e.g., a send button 1602 is depicted by FIG. 16. As mentioned previously, once a connection is made to the touchscreen 805, e.g., via the browser 1400 thereon, the measurement processes start as well as the displaying of such information via the above mentioned webpages 1402, 1502. Closing the browser 1400 disconnects the display/touchscreen 805 and places the microcontroller's VENDGUI API 810 into a monitoring loop which waits for a new connection in which to re-assess the inventor status and provide such measured updates to the touchscreen. The flowcharts depicted by FIGS. 17-19 illustrate the internal functions of the system implemented by the above APIs. These internal functions are used as well to implement the measure algorithm which measures as depicted by FIG. 20. As depicted in FIG. 20, the sensor 707 sends and receives a signal (sound or light) to determine the distance to an object. For example, the transmitter if ultrasonic based sends a high-frequency sound signal and the time between the transmission and reception of the signal allows us to calculate the distance to an object. This is possible because the sound's velocity in the air is known.

A machine configuration, per unit, is saved in a JSON file provided inside a settings folder contained in memory, e.g., on computer 45, memory 165, etc., accessible by the browser 1400 when used by the touchscreen 805. Some information like a pack size or a default column are setup by one of the background processes from the machine configuration but positions like controller type or JSON array position are manually entered by a technician. Example of the file for unit 1 (e.g., machine 800):
[{“Column”:“1”,“height”:“26.40”,“packSize”:“2.2”,“IM_Controller”:“Main”,“IM_position”:0},
{“Column”:“2”,“height”:“26.40”,“packSize”:“2.2”,“IM_Controller”:“Main”,“IM_position”:1},
{“Column”:“3”,“height”:“26.40”,“packSize”:“2.2”,“IM_Controller”: “Main”,“IM_position”:2},
. . .
{“Column”:“93”,“height”:“26.40”,“packSize”:“2.2”,“IM_Controller”:“Main”,“IM_position”:92},
{“Column”:“94”,“height”:“26.40”,“packSize”:“2.2”,“IM_Controller”:“Main”,“IM_position”:93},
{“Column”:“95”,“height”:“26.40”,“packSize”:“2.2”,“IM_Controller”:“Main”,“IM_position”:94},
{“Column”:“96”,“height”:“26.40”,“packSize”:“2.2”,“IM_Controller”:“unit1”,“IM_position”:95},

### Where:

Column—slot number on the machine;
Height—height of the column;
packSize—height of package configured in the slot;
IM_Controller—controller setup (unit 1, unit 2 . . . unit“n”); and
IM_position—the position in JSON array delivered from the VIMS controller.
Using information from such setting files and the value of the measurements from the ultrasonic sensors 707, the following formula is used to calculate the number of products/items 1410 inside every slot 902:

For (i=0;i<max_slot_numer;i++){Qty[i]=(“height”[i]—“result[i]”)/packSize[i];}.

This measurement process/function is illustrated by FIG. 20. The result of which is then displayed on the display/touchscreen 805 as depicted in FIGS. 14 and 15 by the VENDGUI API as discussed previously above.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Many modifications and other embodiments of the inventions will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A live inventory management system, comprising:
a shelf having a plurality of dividers which divide the shelf into a plurality of bins for holding visibly indistinguishable items;
a time of flight based sensor associated with each one of the plurality of bins to detect placement or removal of one or more of the items from the associated bin;
a processor having a memory which stores a list of the items which are held within each of the bins and being in communication with the sensor to receive a detection signal based on time of flight which indicates the placement or removal of the one or more of the items from the associated bin;
an entry device in communication with the processor which sends entered requests for the placement or removal of the one or more items to the processor; and
an indicator strip attached to the shelf, wherein the indicator strip has a set of lights linearly arranged in a single dimension such that an associated subset of the set of lights comprising two or more lights uniquely identifies one of the bins when lit, wherein the strip is in communication with the processor and wherein the processor further includes information relating to which bin each subset of the set of lights of the strip is associated, and wherein selection of at least one of the items from the list via the entry device causes the processor to send a signal to actuate the subset of the set of the plurality of lights which is associated with the bin with the one or more items selected, and to record in memory a type of action being selected from a placement and a removal, a timestamp and a quantity of the one or more items selected placed or removed from the associated bin having the subset of the set of lights light and indicated in the detection signal subsequently received from the sensor of the associated bin.

2. The system of claim 1, wherein the dividers are adjustable to adjust the spacing there-between and in which the information relating to which bin each subset of the set of lights of the strip is associated is set by entering a positional numbering of each light located in the strip for the subset of the set of lights.

3. The system of claim 2, wherein the information relating to which bin each subset of the set of lights of the strip is associated is set and entered by movement and placement of a graphical icon for each divider on a display depicting the shelf and the strip.

4. The system of claim 1, wherein the lights comprise LEDs, and the sensor detects each incidence of the selected item picked or placed from the associated bin via a change when the sensor detects each incidence of the selected item picked or placed from the associated bin via a difference of measurement in the time-of-flight of a transmission and detection of a beam of light from a micro-laser and collector sensor, situated at a back of each bin.

5. The system of claim 1, further comprising a cabinet which contains the shelf, and the cabinet optionally has a lock to prevent access to the shelf when locked, and the shelf is optionally retractable.

6. The system of claim 5, wherein the lock is provided and stays locked until receiving a signal from the processor.

7. The system of claim 1, wherein the process provides an error signal upon the detection signal not being from the associated bin of the one or more selected items.

8. The system of claim 1, further comprising a display which graphically indicates position of the one or more item selected within the shelf via a graphical reproduction of the shelf and strip provided on the display which visibly indicates the associated subset of lights on the display of the bin containing the one or more selected items.

9. The system of claim 8, wherein after selection, branding information of the one or more items is displayed by the processor on a display.

10. The system of claim 8, wherein the graphical reproduction of the shelf and strip is provided via an interstitial, a pop-up window, a modal or an overlay on the display, wherein the display is a touch screen display or a POS device.

11. The system of claim 1, wherein the entry device is a touch screen device and/or a POS device, and the processor activates the subset of lights after selection on the one or more item via the touch screen and graphically indicates position of the one or more item selected within the shelf via a graphical reproduction of the subset of light associated with the bin of the shelf shown lit on the touch screen device and/or a POS device.

12. The system of claim 1, wherein the processor displays on a display various products if the one or more item selected is out of stock or specifically marked for a promotion.

13. The system of claim 1, wherein the processor provides an interstitial of a graphical indication of position of the one or more item selected within the shelf via a graphical reproduction of the subset of light associated with the bin of the shelf shown lit via an Application Programming Interface (API) to a remote application, wherein the remote application is optionally a point-of-sale application.

14. The system of claim 1, wherein the processor provides dispensing and replenishment balances in response to queries received via an Application Programming Interface (API) from a remote application, wherein the remote application is optionally a point-of-sale application.

15. The system of claim 1, wherein the processor transmits at regular intervals locally captured data to a centralized data warehouse.

16. A method for live inventory management that comprises a shelf having a plurality of dividers which divide the shelf into a plurality of bins for holding visibly identifiable items, a time of flight based sensor associated with each one of the plurality of bins to detect placement or removal of one or more of the items from the associated bin, a processor having a memory which stores a list of items which are held within each of the bins and being in communication with the sensor to receive a time of flight detection signal which indicates the placement or removal of one or more items from the associated bin, an entry device in communication with the processor which sends entered requests for placement or removal of the one or more items to the processor, and an indicator strip attached to the shelf, wherein the indicator strip has a set of lights linearly arranged in an single dimension such that an associated subset of the set of lights comprising two or more lights uniquely identifies one of the bins when lit, wherein the strip is in communication with the processor and wherein the processor further includes information relating to which bin each subset of the set of lights of the strip is associated, and wherein selection of at least one of the items from the list of items via the entry device causes the processor to send a signal to actuate the subset of the set of the plurality of lights which is associated with the bin with the one or more items selected, and to record in memory a type of action being selected from a placement and a removal, a timestamp and a quantity of the one or more items selected placed or removed from the associated bin having the subset of the set of lights light and indicated in the detection signal subsequently received from the sensor of the associated bin, said method comprising:
storing in memory:
a list of items which are held within each of the bins, and
information relating to which bin each subset of the set of lights of the strip is associated with each item;
receiving via the processor entered requests for placement or removal of one or more selected items sent from the entry device to the processor;
sending via the processor a signal to actuate the subset of the set of the plurality of lights which is associated with the bin with the one or more selected items; and
recording in memory the type of action selected from a placement and a removal, the timestamp and the quantity of the one or more selected items placed or removed from the associated bin having the subset of the set of lights light and indicated in a detection signal subsequently received from the sensor of the associated bin.

17. The method of claim 16 further comprising:
adjusting at least some of the dividers in the drawer to form a preferred arrangement of the bins; and
entering via the entry device as part of the information stored in memory:
the associated subset of the set of lights comprising two or more lights which uniquely identify one of the bins when lit in the preferred arrangement, and
type of item associated with the associated subset of the set of lights in the preferred arrangement.

18. The method of claim 16, further comprising entering employee identification information via the entry unit, and verifying the entered employee identification information as an authorized employee before permitting the processor to accept a selection of the one or more items.

19. The method of claim 16 further comprising sending, via the processor, a signal to unlock the cabinet containing the one or more items selected.

20. The method of claim 19, further comprising entering employee identification information via the entry unit, and verifying the entered employee identification information as an authorized employee before permitting the processor to accept a selection of the one or more items or send the signal to unlock the cabinet containing the one or more items selected.

21. A retro fit kit for connecting legacy product dispensing machines that require routinely scheduled service visits to update inventory and restocking to a live inventory management environment system, such as located within a convenience store, thereby to enable a so retrofitted dispensing machine to provide on a remote electronic display, over a network, a live inventory of the items held by each slot in the dispensing machine, said kit comprising:
one or more brackets each to mount to a slot which holds items to be dispensed from the dispensing machine;
a time of flight based sensor mounted to a responsive one of the brackets to detect distance to a top item in the associated slot;
a microprocessor to determine quantity of items in each associated slot based on a distance to the top item in the associated slot upon detection by the associated sensor; and
a remote display in communication with the microprocessor which receives and displays the determined quantity of items via color coding,
wherein the microprocessor instructions the sensor to measure and provide the detected distance when the remote display accesses the microcontroller via a browser.

22-23. (canceled)
